(19) United States
(12) Patent Application Publication
(10) Pub. No.: US 2024/0017462 A1
(43) Pub. Date: Jan. 18, 2024

(54) METHOD AND EXTRUDER FOR PREPARING A HIGH QUALITY BLOCK OF IMMOBILIZED ACTIVE MEDIA

(71) Applicant: Arkema Inc., King of Prussia, PA (US)

(72) Inventors: Jialing LIU, Guangxi (CN); Azaz A. VAHORA, King of Prussia, PA (US)

(21) Appl. No.: 18/025,195

(22) PCT Filed: Sep. 20, 2021
(86) PCT No.: PCT/US2021/051029

§ 371 Date: Mar. 8, 2023

(30) Foreign Application Priority Data
Sep. 21, 2020 (CN) 20201095891.4

(51) Int. Cl. B29C 48/395; B29C 48/68; B29C 48/80; B29C 48/63

(52) U.S. Cl. CPC B29C 48/397; B29C 48/684; B29C 48/832; B29C 48/834; B29C 48/63; B29K 2027/16

(57) ABSTRACT

Disclosed is a method and an extruder for making carbon blocks using poly (vinylidene fluoride) (PVDF) as binder and absorbents such as activated carbon.

### FIELD OF THE INVENTION

This invention relates to a method and an extruder for making blocks of active media using poly (vinylidene fluoride) (PVDF) as binder and active media such as activated carbon.

### BACKGROUND

Blocks of immobilized active media, also referred to as blocks or carbon blocks or monoliths, are well established as filters for water filtration applications in order to remove chlorine, taste, odors, and other suspended or dissolved contaminants such as microorganisms and heavy metals from drinking water. Blocks also find uses in other applications such as wastewater filtration, catalyst for chemical reactions, electrodes for battery and supercapacitor, the transport, storage, separation, cleaning of liquids and gases, etc . . .

Blocks are generally made of active media particles or fibers, such as activated carbon, graphite, molecular sieve, metals and derivatives, bactericides, heavy metal removers, etc. The blocks also contains one or more binders, such as polymeric binders, which allow interconnectivity between particles of active media. Polymeric binders can be composed of nearly any thermoplastic material including polyolefins such as polyethylene, polypropylene, etc.; polyvinyls such as polyvinyl chloride, polyvinyl fluoride, polyvinylidene chloride, polyvinylidene fluoride, etc.; polyesters such as polyethylene terephthalate, polybutylene terephthalate, etc.; polyamides, etc. Among these materials, polyethylene and polyesters have been most widely used in the market.

There are two major ways to prepare the blocks. One is by sintering/compression molding, and the other is by continuous extrusion technology. Extrusion is often considered a more cost-effective way to produce blocks.

Arkema has introduced its Kyblock® series of PVDF polymeric binders to the block industries, with demonstrated benefits such as lower binder loading, and improved adhesion to active media particles especially to fine particles. In water filtration applications, PVDF polymer binders also provide improved performance in the removal of contaminants such as chlorine and heavy metals. PVDF polymer binders also bring improved performance in other block applications such as gas transport, storage, separation, and cleaning.

Blocks of this invention comprise a PVDF polymer binder. The PVDF polymer binder includes single PVDF polymer, blends of two or more PVDF polymers, and blends of PVDF polymers with other polymers such as Polyethylene, polyesters and Polyamides.

When one or more PVDF polymer binders are incorporated in the composition of blocks, they usually do not allow for a drop-in replacement in the process and equipment used for the traditional blocks made with polyethylene and polyester binders. Thus, it is challenging for end-users to apply the PVDF polymer binders in their products especially for those using extrusion technology to make blocks.

This invention relates to an inventive extruder to solve the extrusion issues when manufacturing a block containing active media particles such as activated carbon and PVDF polymer binder, enhancing the ease and throughput of the extrusion process, as well as the blocks' quality and performance.

Typical problems encountered during extrusion of the blocks using PVDF polymer binders include 1) the feeding of the particulate blend of active medias and PVDF binder into the extruder barrel, 2) incomplete curing of the binder, and 3) jamming of the extruder barrel where the block locks up inside the barrel. The issue with feeding the particulate blend of materials is largely related to the flow of the powder material, and PVDF binder tends to impair the flow of the overall powder blend due to its small submicron discrete particle size.

The incomplete curing of the block typically comes from the melting temperature of PVDF polymer binders being generally higher than that of PE and polyester binders, and ranging from 110 degree C. to 180 degree C. By curing we mean that the active media particles are bonded by the binder. Blocks made using PVDF polymer typically require higher temperature and/or longer residence time in the heating zone of the extruder. This can result in a partially cured block, for instance when using the type of extruders having an unflighted short heating zone, such as described in WO1992017327A2.

The issue with jamming of the extruder barrel is typically due to high friction of the block against the wall of the extruder barrel. This issue occurs especially for blocks containing small active media particles of less than 100 microns, preferably less than 20 microns, most preferable less than 10 microns. PVDF polymer binders are largely used in such blocks, for instance in the case of activated carbon blocks for health claim filters, which use small active media particles for heavy metal removal. The issue of jamming also occurs with blocks containing PVDF polymer binders, due to the lower binder loading, typically less than 20% preferably less than 16%. This is because polymeric binders act as lubricants and help minimize friction with the extruder wall.

US2016/0121249 A1 and WO2014055473A2 teach using thermoplastic binders (PVDF) as binder in preparing an activated carbon block filter and the method to prepare the same, via compression molding/sintering technology or via extrusion.

WO1992017327A2 describes using an extrusion process to form a solid composite article. Disclosed is an extruder to produce blocks from blends of activated carbon and polyethylene binder. PVDF is not mentioned as a possible binder. Koslow teaches an extruder with short unflighted heating zone in the barrel, where the heating zone is shorter than the die (cooling) zone. It also teaches that a longer heating zone does not work because it causes higher friction of the block with the extruder barrel wall, resulting in jamming of the barrel.

The extruder described in WO1992017327A2 is not well suited for blocks containing PVDF polymer binders. A short and unflighted heating zone typically does not provide enough heat transfer to completely cure blocks containing PVDF polymer binder due to the relatively high melting temperature of PVDF polymers between 110 degree C. and 180 degree C. Therefore the use of such an extruder is limited to very low extrusion rates.

The issue of jamming, or locking up of blocks containing PVDF polymer binder, tends to occur in all existing extruder designs, including those described in WO9217327A2, and those with longer and/or flighted heating zone. Jamming with blocks containing PVDF polymer binder can occur due to low binder loading of less than 30%, preferably less than 18%, most preferably less than 12%, because low binder loading translates into high content of active media particles and higher friction with the extruder barrel. In addition, many applications, such as high-end CTO water filters and health-claim water filters, require a high block density of more than 0.55 g/cm³, preferably more than 0.65, most preferably more than 0.75. In addition such blocks typically contain more than 10%, preferably more than 20%, more preferably more than 30% of fine active media particles of less than 100 microns, preferably less than 50 microns, most preferably less than 10 microns. Both the higher block density and the fraction of fine active media particles also contribute to an increased friction with the extruder barrel that can lead to jamming issues.

Standard extruders like the one described in FIG. 1 have a feeding zone that is flighted, and are typically equipped with a feeder relying on gravity to feed the material from the feeder hoper to the barrel. Particulate blends of active media and polymer binder that contain at least 2 wt % of fine particles of active material and/or polymer binder tend to have poor flow. Poor flow results in uneven feeding to the extruder. The particle size of fine particles is less than 50 micron, preferably less than 20 microns, most preferably less than 10 microns (tested by ro-tap sieve shaker at 10 micron and above, by Microtrac particle analyzer at less than 10 microns). PVDF binders can contain at least 20%, preferably at least 50%, and up to 100% of fine particles. Active media particles can contain fine particles, especially in high-end filtration applications where it is important to maximize the accessible surface area of the media. Typical fine particles of active media include “activated carbon fines”, metal reducers, bactericides, etc . . .

There remains a problem in extruding blocks containing PVDF polymer binders, in that using various existing extrusion equipment, the continuous feeding of blends of active media and PVDF binder is inconsistent, the block is only cured partially, and/or the extruder barrel gets jammed with the block locked-up inside.

Applicants have now designed a novel extruder, which combines a barrel with a flighted heating zone and a forming zone where the diameter of the barrel is modified, such that it is not constant throughout that zone. With such a novel extruder design, the process to make a block containing PVDF polymer binder is improved in that the extruder barrel does not jam.

### SUMMARY OF THE INVENTION

This invention relates to the preparation method and extruder, and more specifically an extrusion process and an extruder, to produce a high quality block product made of poly (vinylidene fluoride) polymeric binder and active media, such as activated carbon particles

### Aspects of the Invention

Aspect 1. An extruder for making a block of active media and PVDF polymer binder, comprising an extruder barrel comprising a flighted heating zone and an unflighted forming zone,
said unflighted forming zone comprises a cooling section,
wherein the heating zone is longer than the forming zone,
wherein the inside diameter of the extruder barrel “D” increases from D₁ to D₂ in the unflighted
forming zone, wherein the change in diameter between D₁ and D₂ is between 0.2% to 1.0%,
wherein the ratio of the heating zone length to the forming zone length is between 20:1 to 5:4.

Aspect 2. The extruder of aspect 1, wherein the increase of diameter D1 to D2 in the forming zone is from 0.2 to 0.9%, preferably 0.35% to 0.70%.

Aspect 3. The extruder of aspect 1 wherein the increase of diameter D1 to D2 is from to 0.65%.

Aspect 4. The extruder of any one of aspect 1 to 3, wherein the change in diameter for from D1 to D2 occurs over 10% to 100% of the length of the forming zone, preferably 30% to 85%, preferably 40% to 75%.

Aspect 5. The extruder of any one of aspects 1 to 4, wherein the ratio of the heating zone length to forming zone length is preferably from 10:1 to 5:4

Aspect 6. The extruder of any one of aspects 1 to 6 wherein the heating zone is from 0.25 to 2.0 meters long, preferably 0.5 to 1.5 m long and comprises 1 to 10 heating sections.

Aspect 7. The extruder of any one of aspects 1 to 7 wherein the forming zone is from 0.01 to 1 meters, preferably 0.02 to 0.5 meters long.

Aspect 8. The extruder of any one of aspects 1 to 7 wherein the forming zone is from to 0.2 meters, preferably 0.05 to 0.15 meters long.

Aspect 9. The extruder of any one of aspects 1 to 8 wherein the cooling section is from 0.01 to 1 meters, preferably 0.02 to 0.5 meters long.

Aspect 10. The extruder of any one of aspects 1 to 8 wherein the cooling section is from 0.05 to 0.2 meters, preferably 0.05 to 0.15 meters long.

Aspect 11. The extruder of any one of aspects 1 to 8 wherein the cooling section comprises from 20 to 100% of the forming zone preferably from 50 to 99% by length.

Aspect 12. The extruder of any one of aspects 1 to 11 wherein the inside diameter of the barrel “D1” in the flighted zone is between 1 cm to 50 cm, more preferably between 3 cm and 25 cm.

Aspect 13. The extruder of any one of aspects 1 to 11 wherein the inside diameter of the barrel “D1” in the flighted zone is between 1 cm to 25 cm, preferably between 3 cm to 6 cm.

Aspect 14. The extruder of any one of aspects 1 to 13 wherein the extruder further comprises a feeder hopper, said feeder hopper comprising an auger.

Aspect 15. The extruder of any one of aspects 1 to 14 wherein the extruder further comprises an external backpressure device.

Aspect 16. The extruder of aspect 15 wherein the external backpressure device is selected from the group consisting of a puller, weights, or a donut device composed of springs and fingers that attaches to the block.

Aspect 17. A method for extruding a block of active media and PVDF polymer binder the method comprising providing PVDF polymer binder comprising PVDF polymer and active media, feeding the PVDF polymer binder and active media into the extruder of any of aspects 1 to 14 and extruding the resulting PVDF polymer binder and active media blend to form a block of immobilized media.

Aspect 18. A method for extruding a carbon block the method comprising
a. providing PVDF polymer binder and active media,
b. providing an extruder comprising an extruder barrel, said extruder barrel comprising a flighted heating zone and an unflighted forming zone, said forming zone includes a cooling section, wherein the ratio of the heating zone length to the forming zone length is between 20:1 to 5:4, wherein the inside diameter of the extruder barrel “D” increases from D₁ to D₂ in the forming zone, wherein the change in diameter between D₁ and D₂ is between 0.2% to 0.9%,
c. feeding the PVDF polymer binder and active media to the extruder,
d. extruding the PVDF polymer binder and active media blend to form a block of immobilized media.

Aspect 19. The method of aspect 17 or 18 wherein the PVDF polymer binder comprising PVDF polymer and active media are blended prior to being feed to the extruder.

Aspect 20. The method of any one of aspects 17 to 19 wherein the heat zone temperatures are from 20 degree C. below the melting temperature of the binder, up to 80 degree C. above the melting temperature of the binder.

Aspect 21. The method of any one of aspects 17 to 19 wherein the heat zone temperatures are between 130 to 260C preferably from 170 and 230 degree C.

Aspect 22. The method of any one of aspects 17 to 21 wherein the binder comprises a VDF/HFP copolymer having a melt viscosity of from 5 to 80kP, preferably from 15 to 50 kP.

Aspect 23. The method of any one of aspects 17 to 22 wherein the PVDF polymer comprises from 5% to 20% by weight HFP.

Aspect 24. The method of any one of aspects 17 to 23 wherein the combination of active media and polymer binder contain at least 2 wt % or more of fine particles

Aspect 25. The method of any one of aspects 17 to 24 wherein the PVDF polymer comprises discrete PVDF polymer particles of from 50 to 500 nm in size, as an average discrete particle size and agglomerates of the discrete polymer particles said agglomerates are from 1 to 150 micrometer in size preferably from 3-50 micrometers as measured by electron scanning microscope.

Aspect 26. The method of any one of aspects 17 to 25 wherein the PVDF polymer binder contains at least 20%, preferably at least 50%, and up to 100 wt % of fine particles.

Aspect 27. The method of any one of aspects 17 to 26 wherein the sorbent comprises activated carbon.

Aspect 28. The method of any one of aspects 17 to 27 wherein the binder comprises from 1 to 30 weight percent, preferably from 1 to 10 weight percent based on the total weight of the binder and sorbent.

Aspect 29. The method of any one of aspects 17 to 28 wherein the block of active media and PVDF polymer binder has a density of up to 0.95 g/cc preferably between 0.50 and 0.90 g/cc and more preferably from 0.65 to 0.85 g/cc.

Aspect 30. The method of any one of aspects 17 to 29 wherein the extruder produces a block of active media and PVDF polymer binder at a rate of from 0.5 cm to 50 cm of extruded block per minute, preferably 0.5 to 30 cm/min.

Aspect 31. The method of any one of aspects 17 to 30 wherein the heating zone is from to 2 m long , preferably 0.5 to 1.5 m long meters long, wherein the forming zone is from 0.075 to 0.20 meters long, wherein the cooling section comprises from 27 to 72% of the forming zone and wherein the expansion of D1 to D2 along with the barrel of the extruder is from 0.3% to 0.7%.

Aspect 32. The method of any one of aspects 17 to 31 further comprising exerting backpressure on the extruding block.

### BRIEF DESCRIPTION OF THE FIGURES

FIG. 1 Diagram of Existing Extruder Barrel, optionally equipped with an inside solid rod to produce hollow cylindrical blocks. The barrel is composed of three zones, a feeding zone, a heating zone, and a forming zone that comprises a cooling section. The feeding zone is unheated and flighted, positioned right underneath the feeder's hopper and ends at the edge of the hopper. The heating zone is flighted and is longer than the unflighted forming zone. The heating zone starts at the edge of the feeding hopper until the end of the flighted section. In a standard extruder, the diameter of the feeding, heating and forming zones is constant along the entire length of the barrel. The forming zone is unflighted and usually does not have heating elements. The forming zone begins at the end of the flighted section and goes to the end of the barrel. The forming zone usually contains a cooling section, where cooling elements are used.

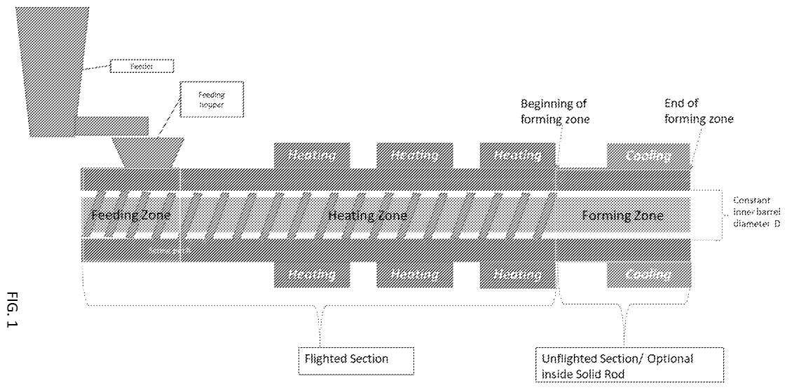

FIG. 2 Schematic of Inventive Extrusion Barrel, optionally equipped with an inside solid rod to produce hollow cylindrical blocks. The barrel is composed of three zones; a feeding zone, a heating zone, and a forming zone that comprises a cooling section. The schematic shows the heating zone and the forming zone. The feeding zone (not shown) is unflighted and is usually not heated, but it can be heated. The heating zone is flighted and is equipped with heating elements, preferably located on the external surface of the barrel. The forming zone is unflighted and is usually not heated. The cooling section, within the forming zone, is equipped with cooling elements. Preferably located on the external surface of the barrel. In the forming zone, the inner barrel diameter “D” has been modified along the length of the barrel, so that the final barrel inner diameter at the exit of the cooling section (D₂) is larger than the initial barrel inner diameter at the beginning of the unflighted zone (D₁). The modification of the inner barrel diameter “D” can be gradual along the whole length of the unflighted zone, or can be done in increments. The heating zone is the longest zone in the barrel.

### DETAILED DESCRIPTION OF THE INVENTION

All references listed in this application are incorporated herein by reference. All percentages in a composition are weight percent, unless otherwise indicated. Combinations of different elements described herein are also considered as part of the invention.

“Interconnectivity”, as used herein means that the active media particles or fibers are permanently bonded together by the polymer binder particles without completely coating their surfaces. During a process called “curing”, the binder softens and adheres the active media particles at specific discrete points to produce an organized, porous structure. The block produced by the method of the invention is porous. The block allows a fluid to pass through the interconnected particles or fibers, and the fluid is exposed directly to their surface(s) favoring the adsorption of components of the fluid onto the active media. Since the polymer binder adheres to the active media particles in only discrete points, less binder is used for complete interconnectivity compared to a binder that is coated onto the active media.

An extruder for preparing a block of active media and PVDF binder is disclosed.

A method of extruding a block of active media and PVDF binder using the inventive extruder is disclosed.

The present invention provides for the extrusion of a block of active media, such as activated carbon, utilizing PVDF as the binder. The extruder has a novel barrel design, modified compared to existing extruder barrels used to produce blocks. The novel extruder of this invention allows to successfully extrude blocks of active media and PVDF binder where the block does not lock up in the barrel in a jamming event.

The invention provides for the modification of an extruder for the extrusion of immobilized active media blocks, wherein the extruder barrel is modified in the forming zone, such that the modified inner diameter at the exit of the barrel (D2) is larger than the inner diameter in the flighted zone or at the beginning of the unflighted zone (D1).

### Extrusion Apparatus

The modified extruder barrel comprises three zones 1) a feeding zone, 2) a heating zone, 3) a forming zone which includes a cooling section.

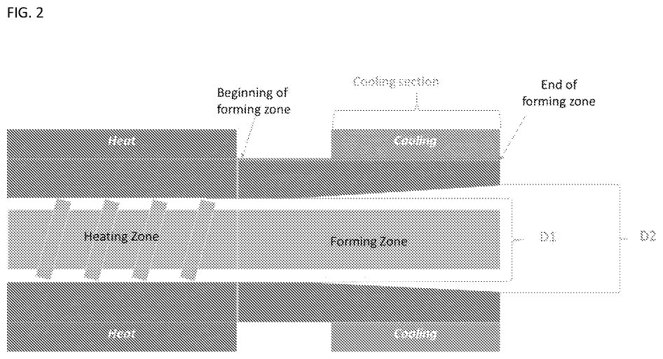

The feeding zone is flighted and usually not heated, it receives the material from the feeder and carries the material into the heating zone. The heating zone is flighted, has heating elements, and is the longest zone in the barrel, to ensure adequate heat transfer and complete cure of the block. The forming zone is unflighted, it is typically not heated, although part of it may optionally be heated. Within the forming zone, the cooling section is unflighted, equipped with cooling elements. The extruder barrel is modified in the forming zone, such that the modified inner diameter at the end of the forming zone (D2) is larger than the inner diameter at the beginning of the forming zone (D1), as showed on FIG. 2. The ratio of the length of the heating zone to the length of the forming zone is preferably from 20:1 to 5:4, preferably 10:1 to 5:4, preferably from 8:1 to 6:4.

The absolute lengths of the barrel and the barrel zones will depend of the thickness of the block. For instance, the thickness of a solid cylinder block is the outer diameter of the block, and the thickness of a hollow cylinder block is the defined as the difference of outer diameter minus inner diameter of the block.

The feeding zone can be from 0.1 to 1 meter long, preferably 0.2 to 0.5 m.

The heating zone is longer than the forming zone, and can be from 0.25 to 2 m long, preferably 0.5 to 1.5 m long. It is equipped with 1 to 10 heating elements, preferably 3 to 5 heating elements. The temperature of the heating elements can be set between room ambient temperature and 300 degree C., and are typically from 20 degree C. below the melting temperature of the binder, up to 80 degree C. above the melting temperature of the binder. The temperature of each element can be controlled independently.

The forming zone can be from 0.01 to 1 meters, or 0.02 to 0.7, preferably 0.05 to 0.5 meters long. The cooling section within the forming zone can be from 0.01 to 1 meters long, preferably 0.02 to 0.5 meters or 0.05 to 0.20 or even more preferably 0.05 to 0.15 m. The cooling section is equipped with one or more cooling elements. A cooling element can contain a cooling fluid, such as water or other coolant, which can optionally be refrigerated. The temperature of the cooling fluid can be between 90 C and −20 C, preferably 35C to 0 C.

In the forming zone, the inner barrel diameter “D” has been modified so that the final barrel inner diameter at the end of the forming zone is 1.002-1.01 times larger than the initial barrel inner diameter at the beginning of the forming zone, or 1.002 -1.009 times larger, preferably 1.003-1.007 times larger, most preferably 1.004-1.007 times larger. The gradient modification of the inner barrel diameter D can occur in the forming zone only. The modification occurs over a length of 10% to 100%, preferably 30% to 85%, preferably 40% to 75%, more preferably 50 to 70% of the length of the forming zone, and can happen in a continuous manner or in one or more step changes. This percentage is calculated as the ratio of the total length of the modified section to the total length of the forming zone (which includes the cooling section). The length of the modified section is measured from the point where the inner diameter of the barrel is first modified in the forming zone, until the end of the barrel at the exit of the cooling section. The gradient modification allows to compensate for the contraction of the die, where metallic alloy is used which contracts more than polymeric binder and the active media being extruded, and releases the pressure built up in the die. After the gradient modification is completed, the final barrel inner diameter at the end of the forming zone (D₂) is larger than the initial barrel inner diameter at the beginning of the forming zone (D₁). The overall increase of the barrel inner diameter, between Di and D2 is from 0.2% to 1.0%, from 0.2% to 0.9%, preferably from 0.35% to 0.7%, most preferably from 0.4% to 0.65%. The percent increase is calculated as below:

% increase of D=100*(D2−D1)/D1

The barrel inner diameter in the flighted zone, D1, is preferably between 1 cm to 50 cm, more preferably between 3 cm and 25 cm. D1 could be as large as 100 cm or more. The D1 can be 1 cm to 25 cm or between 3 cm to 6 cm or 4 cm to 5 cm. In the case of a hollow structure, typical inside diameters of the hallow in the structure are 0.5 cm to 45 cm, and more preferably 1 cm to 15 cm or from 1 to 10 cm.

In one example embodiment, barrel inner diameter in the flighted zone, D₁, is 4.35 cm and is modified with a 0.5% increment gradient to a barrel inner diameter at the exit of the cooling section, D₂, of 4.372 cm.

Additionally this type of extruders can also be equipped with an external device capable of resisting the block from exiting the extruder, which helps create a backpressure to densify the block. This can be achieved by a typical puller used in plastic industries by resisting the rate of extrusion, putting weights in front of the extrudate, or a simple device (aka donut) composed of springs and fingers that grabs a block and exerts pressure proportionally to the spring constant of the springs. There are other means of creating backpressure to help densify the block that can be used in conjunction with the extruder of the invention to create denser carbon block. An internal design modification can also be made to densify the block that includes modifying the inner diameter in the heating zone to create material built up. In such case, the inner diameter of the barrel at the end of the heating zone is smaller than the inner diameter of the barrel at the beginning of the heating zone.

Furthermore, feeding equipment known as feeder, is typically also used in combination with an extruder. They are composed of a hopper that take a large amount of material and feeds the material into extruder at steady rate. However, typical feeder hoppers have issues with consistently feeding the particulate blends of active media and polymer binder that contain at least 2 wt % or more, of fine particles of active material and/or polymer binder due to poor flow properties. We have now found that this issue is eliminated by adding an auger inside the feeder's hopper, which helps agitate the powder for consistent feeding.

Finally, the extruder can also be set up with an inline block cutter, which helps cut the extruded block to a specific length.

With the new inventive design of the extruder, the jamming issue when making a block containing PVDF polymer binder is resolved. The new extruder design also improves the consistency of continuous feeding of material in the extruder barrel, and ensures the complete curing of the block. Hence, this invention is providing block manufacturers with a highly productive and consistent way to prepare blocks of immobilized active media.

The inventive extruder is designed to extrude blocks comprising active media and PVDF polymer binder.

### Binder

The binder in the block produced using the inventive extruder comprises a poly(vinylidene fluoride) PVDF polymer binder. The PVDF polymer binder can be a single PVDF polymer, a blend of two or more PVDF polymers, or a blend of PVDF polymer with other polymers such as polyethylene, polyesters, or any other thermoplastic polymer. In some embodiments the PVDF polymer binder is a blend of PVDF binder and other polymers, the PVDF is the major component of the total binder, comprising greater than 50%, PVDF polymer based on total polymer binder. Some embodiment the PVDF is not the major component and can be as low as 10% of the overall binder content of the block. The PVDF polymer is a homopolymer of vinylidene fluoride or a copolymer of vinylidene fluroride with one or more comonomers. Copolymers have lower melting temperature and lower modulus compared to homopolymers. Lower melting temperature of the binder helps ease the issues of locking up the extruder.

Preferred PVDF copolymers include those containing at least 50 mole percent, preferably at least 75 mole %, more preferably at least 80 mole %, and even more preferably at least 85 mole % of vinylidene fluoride (VDF) copolymerized with one or more comonomers selected from the group consisting of tetrafluoroethylene, trifluoroethylene, chlorotrifluoroethylene, hexafluoropropene (HFP), vinyl fluoride, pentafluoropropene, tetrafluoropropene, trifluoropropene, perfluoromethyl vinyl ether, perfluoropropyl vinyl ether, (meth)acrylic acid, (meth)acrylate esters, and any other monomer that would readily copolymerize with vinylidene fluoride. The comonomer is preferably hexafluoropropene.

In one embodiment, the vinylidene fluoride polymer comprises up to 30% by weight, preferably up to 25%, and more preferably up to 15% of HFP units and 70% or greater, preferably 75% or greater, more preferably 85% or greater by weight of VDF units. The PVDF polymer can have from 0 to 30% by weight, preferably from 5 to 20% by weight HFP units.

The PVDF used in the invention is generally prepared by means known in the art, using aqueous free-radical emulsion polymerization—although suspension, solution and supercritical CO₂ polymerization processes may also be used. Preferably, the PVDF is produced by emulsion polymerization).

The surfactant used in the polymerization can be any surfactant known in the art to be useful in PVDF emulsion polymerization, including perfluorinated, partially fluorinated, and non-fluorinated surfactants. Preferably the PVDF emulsion of the invention is fluorosurfactant-free, with no fluorosurfactants being used in any part of the polymerization. Non-fluorinated surfactants useful in the PVDF polymerization could be both ionic and non-ionic in nature including, but are not limited to, 3-allyloxy-2-hydroxy-1-propane sulfonic acid salt, polyvinylphosphonic acid, polyacrylic acids, polyvinyl sulfonic acid, and salts thereof, polyethylene glycol and/or polypropylene glycol and the block copolymers thereof, alkyl phosphonates and siloxane-based surfactants. In one embodiment, the emulsion polymerization is conducted in the absence of any surfactant.

The latex polymer binder is generally reduced to a powder form by spray drying, coagulation, or other known process, to produce a dry powder. The powder shape and particle size may be modified by any know process, such as milling.

Discrete PVDF binder particles are generally from 5 to 700 nm in size, preferably from 50 to 500 nm, and more preferably from 100-300 nm as an average discrete particle size. In some cases, discrete polymer particles can agglomerate into 1 to 150 micrometer groupings, 3 -micrometers and preferably 5-15 micrometers agglomerates. It has been found that some of these agglomerates can break down into discrete particles or fibrils during processing to an article. Some of the binder particles are discrete particles, and remain as discrete particles in the formed block article. During processing into block articles, the particles adjoin active media together and provide interconnectivity.

It is important that as little binder is used as necessary to hold the active materials together, as this allows more of the surface area of the active media to be exposed and be available for interaction with fluid, for instance during filtration or adsorption processes. One advantage of PVDF polymers, is that they have a very high specific gravity of at least about 1.75 g/cc, preferably at least about 1.77 g/cc. Thus the low weight percent of binder needed represents an even lower volume percent.

The molecular weight of the PVDF polymer is not particularly limited. It is preferred that the molecular weight is high, to assist in the binder not flowing into the active media and fouling the high surface area of the activated carbon in one case. The melt viscosity of the polymer is preferably from 1 to 100 kPoise, preferably 5 to 80 kPoise, from 5 to 60 kP, most preferably from 15 to 50 kPoise. Melt viscosity of the polymer is measured according to ASTM D3835 by a capillary rheometry at 232° C. and 100 sec−1.

### Active Media

Active media used are those known to be used in block products. The block product can be used for filtration such as water filtration or can be used for the transport, storage, separation, cleaning of fluids (gas or liquid) by choosing the correct active media. The active media particles is not particularly limited. Examples of active media include but are not limited to powder particles or fibers of activated carbon, graphite, molecular sieve, metals and derivatives, bactericides, and heavy metal removers and combination thereof. One preferred active media is activated carbon.

The active media particles of the invention are generally in the size range of 0.1 to 3,000 microns, preferably from 1 to 500 microns, and most preferably from 5 to 100 microns in diameter. In certain embodiments, active media particles have a multimodal particle size distribution, for instance with some particles having an average particle size of less than 100 microns, and some particles having an average particle size of more than 200 microns. Active media particles can also be in the form of fibers of 0.1 to 250 microns in diameter of essentially unlimited length to width ratio. Fibers are preferably chopped to no more than 5 mm in length.

Active media fibers or powders should have sufficient thermal conductivity to allow heating of the powder mixtures. In addition, in an extrusion process, the particles and fibers must have melting points sufficiently above the melting point of the PVDF polymer binder to prevent both substances from melting and producing a continuous melted phase rather than the usually desired multi-phase system.

### Process

The PVDF polymer binder and active media may be blended and processed. The PVDF polymer binders are generally in a powder form, which can be dry blended with the active media. Preferably, 0.5 to 35, preferably 1 to 30, and more preferably 3 to 25 weight percent of PVDF polymer binder is used in the block product based on the total weight of active media and PVDF polymer binder. The weight percent of PVDF could be from 1 to 10 weight percent based on the total weight of active media and PVDF polymer binder.

In the case where a very dense block is desired, extrusion processing at higher pressures can be used. The extrusion processes are practiced in a manner that causes a softening of the polymer binder particles, but does not cause them to melt and flow to the point that they contact other polymer particles and form agglomerates or a continuous layer. To be effective in the contemplated end-uses, the polymer binder remains as discrete polymer particles that bind the active media particles into an interconnected web, for good permeability. Solvents that dissolve the binder are not used in the present invention because in a solvent system, individual polymer particles no longer exist, as the particles are dissolved and form a continuous coating over the active media particles. A continuous coating reduces the amount of activated surface area available for interaction of a fluid with the active particles, and can reduce their overall effectiveness.

The active media and polymer binder are formed into a block article in an extrusion process. The blocks of the invention are formed by an extrusion process. A general extrusion process for carbon blocks is described in U.S. Pat. No. 5,331,037. U.S. Pat. No. 5,331,037 describes the extrusion of blocks made with polyethylene binders using an extruder with a barrel having a short unflighted heating zone. PVDF is not mentioned as a possible binder.

The polymer binder/active media composite of the invention is generally dry-blended, optionally with other additives, such as processing aids, and extruded. Continuous extrusion under heat, pressure and shear can produce an infinite length 3-dimensional multi-phase profile structure. A continuous web of forced-point bonding of binder to the active media particles, is formed under the extruder conditions.

The extrusion process can produce a continuous block structure at any diameter and length desired. Lengths of 1 cm to hundreds of meters are possible with the right manufacturing equipment. The continuous solid block can then be cut into desired final lengths. The block can be solid or hollow. Typical outside diameters of the blocks would be preferably be 1 cm to 50 cm, and more preferably 3 cm to 25 cm—though with the proper size die(s) larger diameter structures up to 100 cm and larger could be produced. In the case of a hollow structure, typical inside diameters are 0.5 cm to 45 cm, and more preferably 1 cm to 15 cm, or from 1 to 10 cm.

An alternative to a single structure, is forming two or more structures—a solid rod, and one or more hollow block cylinders designed to nest together to form the larger structure. Once each annular or rod-shaped block component is formed, the components can be nested together to create a larger structure. This process can provide several advantages over the extrusion of a single large structure. The blocks with smaller cross-sectional diameter can be produced at a faster rate than producing a large, solid, single-pass block. The cooling profile can be better controlled for each of the smaller-cross sectional pieces. A further advantage of this concept may be reduced gas diffusion path lengths through the monoliths as the spacing between concentric blocks could serve as channels for rapid flow of gas.

### Properties

Articles formed by the invention are high quality, robust, block structures of active media and binder. The density of the block can be fine-tuned, for example it can be very high to maximize the volume of active media, in order to maximize block efficiency.

The inventive extruder provides for blocks with a density of up to 0.95 g/cc. Preferably, the density of the block product is between 0.50 and 0.90g/cc available, more preferably 0.65 to 0.85 g/cc.

The inventive extruder provides for higher productivity due to reduced friction of composition particles with the extruder walls. The inventive extruder can provide for a production of up to 0.5 cm to 50 cm per minute of extruded block per minute, preferably up to 1 cm to 30 cm per minute.

The heating zone temperatures are generally driven by the softening temperature of the binder, and are typically from 20 degree C. below the melting temperature of the binder, up to 80 degree C. above the melting temperature of the binder. For example, the temperatures are generally between 130C to 260C, and can be from 170 to 230C. The temperatures could be lower or higher than these examples depending on the polymer binder.

The novel extruder barrel provides continuous extrusion with fine particulates using PVDF polymer binder achieved while minimizing the lock up issue experienced using the traditional extruder.

### EXAMPLES

### Example 1

The extruder barrel comprises a 1 m flighted heating zone, a 0.23 m forming zone, which has a 0.115 m cooling section. The initial barrel inner diameter in the flighted zone is D1=4.35 cm, and the final barrel inner diameter at the exit of the extruder is D2=4.372 cm (0.5% modification). The modification of the inner diameter occurs along 0.172 m of the length of the unflighted forming zone. The barrel is equipped with an inside rod to extrude a hollow cylinder block. The rod diameter is equal to the hollow block inner diameter and is ID=1.9 cm. The thread gap is 4 cm. (made with CrMoA1).

The formulation contains 8% binder (by weight) (Kyblock® FG-81) and 92% (by weight) activated carbon of size 80*325 from Jaccobi.

The processing conditions are as follow:
A. The binder and the carbon are mixed in a rotary mixer for 1 h under low speed.
B. Extrusion conditions: 190° C., 200° C., 150° C., 105° C. (T1 T2 T3 & T4);

The resulting block has a density of 0.75g/cm³ (measured by weight/volume after the block is cooled down). The line speed to produce the block is 8 cm/min.

The block density indicates the mechanical strength and shows the stability of the process. The extruder ran for 3 hours without any issue (no locking up). This contrasts with the case where the same block composition was run on the extruder with a non-modified barrel that had a constant inner diameter of D1=4.35 cm. In the case of the non-modified barrel, the extruder locked up within the first 30 minutes and the block got stuck inside the barrel.

### Example 2

The extruder barrel is the same as for Example 1.

The formulation contains 25% (by weight) binder (Kyblock® FX-415) and 75% (by weight) activated carbon of size 80*325 from Jacobi.

The processing conditions are as follow
A. The binder and the carbon are mixed in a rotary mixer for 1 h under low speed.
B. Extrusion conditions: Four heating zones: 170° C., 180° C., 150° C., 105° C. (T1 T2 T3 & T4);

The resulting block has a density of 0.8 g/cm³ (measured by weight/volume after the block is cooled down). The line speed to produce the block is 8 cm/min

The block density indicates the mechanical strength and shows the stability of the process.

The extruder ran for 3 hours without an issue (no locking up). As in Example 1, this contrasts with the case of a non-modified barrel which led to the lock up of the extruder.

### Example 3

A powder blend containing 8% binder (by weight) (Kyblock® FG-81) and 92% (by weight) activated carbon of size 80*325 from Jaccobi, was fed into an extruder barrel using two different feeders. All of the binder is considered to be fine particles, which tend to impair the flow of the overall powder blend in typical feeder devices. In one comparative case where a standard feeder made with a simple hopper design (no auger) was used, the feeding of the powder blend into the extruder barrel was inconsistent. The powder tended to adhere to both the hopper walls and to itself, resulting in a “stop and go” feeding profile. In the case where the feeder's hopper was modified with an auger, the powder was fed at a constant rate, without any inconsistencies. The use of the feeder's hopper modified with an auger, was key to allow the formulation containing more than 2% fine particles to be fed consistently into the extruder. The combination of consistent powder feeding and the use of the modified extruder barrel is necessary to make a quality carbon block product.

1. An extruder for making a block of active media and PVDF polymer binder, comprising an extruder barrel comprising a flighted heating zone and an unflighted forming zone, said unflighted forming zone comprises a cooling section,
wherein the heating zone is longer than the forming zone,
wherein the inside diameter of the extruder barrel “D” increases from D₁ to D₂ in the unflighted forming zone, wherein the change in diameter between D₁ and D₂ is between 0.2% to 1.0%,
wherein the ratio of the heating zone length to the forming zone length is between 20:1 to 5:4.

2. The extruder of claim 1, wherein the increase of diameter D1 to D2 in the forming zone is from 0.2 to 0.9%.

3. The extruder of claim 2, wherein the increase of diameter D1 to D2 is from 0.4% to 0.65%.

4. The extruder of claim 1, wherein the change in diameter for from D1 to D2 occurs over 10% to 100% of the length of the forming zone.

5. The extruder of claim 1, wherein the ratio of the heating zone length to forming zone length is from 10:1 to 5:4

6. The extruder of claim 1, wherein the heating zone is from 0.25 to 2.0 meters long and comprises 1 to 10 heating sections.

7. The extruder of claim 1, wherein the forming zone is from 0.01 to 1 meters.

8. The extruder of claim 1, wherein the forming zone is from 0.05 to 2.0 meter.

9. The extruder of claim 1, wherein the cooling section is from 0.01 to 1 meters.

10. The extruder of claim 1, wherein the cooling section is from 0.05 to 0.2 meters.

11. The extruder of claim 1, wherein the cooling section comprises from 20 to 100% of the forming zone by length.

12. The extruder of claim 1, wherein the inside diameter of the barrel “D” in the flighted zone is between 1 cm to 50 cm.

13. The extruder of claim 1, wherein the inside diameter of the barrel “D” in the flighted zone is between 1 cm to 25 cm.

14. The extruder of claim 1, wherein the extruder further comprises a feeder hopper, said feeder hopper comprising an auger.

15. The extruder of claim 1, wherein the extruder further comprises an external backpressure device.

16. The extruder of claim 15, wherein the external backpressure device is selected from the group consisting of a puller, weights, or a donut device composed of springs and fingers that attaches to the block.

17. A method for extruding a block of active media and PVDF polymer binder the method comprising providing PVDF polymer binder comprising PVDF polymer and active media, feeding the PVDF polymer binder and active media into the extruder of claim 1 and extruding the resulting PVDF polymer binder and active media blend to form a block of immobilized media.

18. A method for extruding a carbon block the method comprising
providing PVDF polymer binder and active media,
providing an extruder comprising an extruder barrel, said extruder barrel comprising a flighted heating zone and an unflighted forming zone, said forming zone includes a cooling section, wherein the ratio of the heating zone length to the forming zone length is between 20:1 to 5:4, wherein the inside diameter of the extruder barrel “D” increases from D₁ to D₂ in the forming zone, wherein the change in diameter between D₁ and D₂ is between 0.2% to 0.9%,
feeding the PVDF polymer binder and active media to the extruder,
extruding the PVDF polymer binder and active media blend to form a block of immobilized media.

19. The method of claim 17, wherein the PVDF polymer binder comprising PVDF polymer and active media are blended prior to being feed to the extruder.

20. The method of claim 17, wherein the heat zone temperatures are from 20 degree C. below the melting temperature of the binder, up to 80 degree C. above the melting temperature of the binder.

21. The method of claim 17, wherein the heat zone temperatures are between 130 to 260C.

22. The method of claim 17, wherein the binder comprises a VDF/HFP copolymer having a melt viscosity of from 5 to 80 kP.

23. The method of claim 17, wherein the PVDF polymer comprises from 5% to 20% by weight HFP.

24. The method of claim 17, wherein the combination of active media and polymer binder contain at least 2 wt % or more of fine particles.

25. The method of claim 17, wherein the PVDF polymer comprises discrete PVDF polymer particles of from 50 to 500 nm in size, as an average discrete particle size and agglomerates of the discrete polymer particles said agglomerates are from 1 to 150 micrometer in size as measured by electron scanning microscope.

26. The method of claim 17, wherein the PVDF polymer binder contains at least 20% and up to 100 wt % of fine particles.

27. The method of claim 17, wherein the sorbent comprises activated carbon.

28. The method of claim 17, wherein the binder comprises from 1 to 30 weight percent based on the total weight of the binder and sorbent.

29. The method of claim 17, wherein the block of active media and PVDF polymer binder has a density of up to 0.95 g/cc.

30. The method of claim 17, wherein the extruder runs at a rate of from 0.5 cm to 50 cm of extruded block per minute.

31. The method of claim 17, wherein the heating zone is from 0.25 to 2 m long.
wherein the forming zone is from 0.075 to 0.20 meters long, wherein the cooling section comprises from 27 to 72% of the forming zone and wherein the expansion of D1 to D2 along with the barrel of the extruder is from 0.3% to 0.7%.

32. The method of claim 17, further comprising exerting backpressure on the extruding block.
